(19) United States
(12) Patent Application Publication
(10) Pub. No.: US 2011/0239731 A1
(43) Pub. Date: Oct. 6, 2011

(54) FORCE MEASUREMENT SYSTEM

(75) Inventors: Jason Lisseman, Shelby Township, MI (US); Jerome Bosch, Romeo, MI (US); Steve Maurer, Sterling Heights, MI (US); Mike Scavnicky, Northville, MI (US)

(73) Assignee: TK Holdings Inc.

(21) Appl. No.: 13/074,739

(22) Filed: Mar. 29, 2011

Related U.S. Application Data
(60) Provisional application No. 61/319,047, filed on Mar. 30, 2010.

(51) Int. Cl. G01N 3/30

(52) U.S. Cl. 73/12.01

(57) ABSTRACT

A system for measuring forces during a simulated dynamic vehicle event includes a plurality of sensors, a controller, and a plurality of conductors that electrically couple each sensor to the controller. Each sensor includes a layer of pressure sensitive material arranged between an outer sheet of carrier material and an inner sheet of carrier material. The pressure sensitive material changes resistance in response to forces acting upon the outer sheet of carrier material. Each of the plurality of sensors is configured to be coupled to a surface of a crash test dummy or to a surface of a vehicle. The controller is configured to provide an electrical signal to each sensor, to measure the voltage across each sensor, and to determine the force acting upon each sensor based on the measured voltage.

### CROSS-REFERENCE TO RELATED PATENT APPLICATIONS

This application claims priority from Provisional Application U.S. Application 61/319,047, filed Mar. 30, 2010, incorporated herein by reference in its entirety.

### BACKGROUND

The present application relates generally to the field of crash test dummies. More specifically, this application relates to a sensor system for measuring forces acting on a crash test dummy during dynamic simulations of vehicle events.

### SUMMARY

A system for measuring forces during a simulated dynamic vehicle event includes a plurality of sensors, a controller, and a plurality of conductors that electrically couple each sensor to the controller. Each sensor includes a layer of pressure sensitive material arranged between an outer sheet of carrier material and an inner sheet of carrier material. The pressure sensitive material changes resistance in response to forces acting upon the outer sheet of carrier material. Each of the plurality of sensors is configured to be coupled to a surface of a crash test dummy or to a surface of a vehicle. The controller is configured to provide an electrical signal to each sensor, to measure the voltage across each sensor, and to determine the force acting upon each sensor based on the measured voltage.

A sensor for measuring forces during a simulated dynamic vehicle event includes outer and inner carrier sheets, first and second conductors, and a pressure sensitive material that changes electrical resistance in response to force acting thereupon. The first conductor is coupled to an interior surface of the outer carrier sheet, and the second conductor is coupled to an interior surface of the inner carrier sheet. The pressure sensitive material is physically and electrically coupled to one of the first and second conductors. The sensor is configured to be coupled to a surface of a crash test dummy or to a surface of a vehicle.

### BRIEF DESCRIPTION OF THE DRAWINGS

FIG. 1 is a top view of a sensor sheet according to an exemplary embodiment.

FIG. 2 is sectional view of a sensor according to an exemplary embodiment.

FIG. 3 is a graph of theoretical resistance characteristics of a sensor according to an exemplary embodiment.

FIG. 4 is a front view of crash test dummies according to an exemplary embodiment.

FIG. 5 is a front view of a chest and shoulder zone according to an exemplary embodiment.

FIG. 6 is a front view of a head and face zone according to an exemplary embodiment.

FIG. 7 is a front view of a chin subzone according to an exemplary embodiment.

FIG. 8 is a block diagram of the sensor system according to an exemplary embodiment.

### DETAILED DESCRIPTION

According to an exemplary embodiment, a pressure sensor system is provided to detect forces and/or force mapping during simulated dynamic impact events (e.g., crash or sled tests). More particularly, the pressure system is configured to measure forces acting upon the crash test dummy during a simulated dynamic impact event. Measured force data may then be used in development of safety devices for vehicles.

As discussed in further detail below, the pressure sensor system generally includes one or more sensor sheets. Each sensor includes one or more pressure sensors, which predictably change conductive characteristics in response to forces. Each sensor sheet is configured to be coupled, removably or irremovably, to the outer surface of a crash test dummy, or to be integrally formed with the surface of the crash test dummy. The sensor sheets are configured to be thin and light, such that the outer surface of the sensor sheet is representative of the outer surface of the crash test dummy and that measurements taken are representative of forces that would otherwise act upon the outer surface of the crash test dummy. A controller or measuring device is configured to send an electrical signal to each of the sensors and to measure the return signal voltage or current, which may then be used to determine the force or pressure acting upon each sensor.

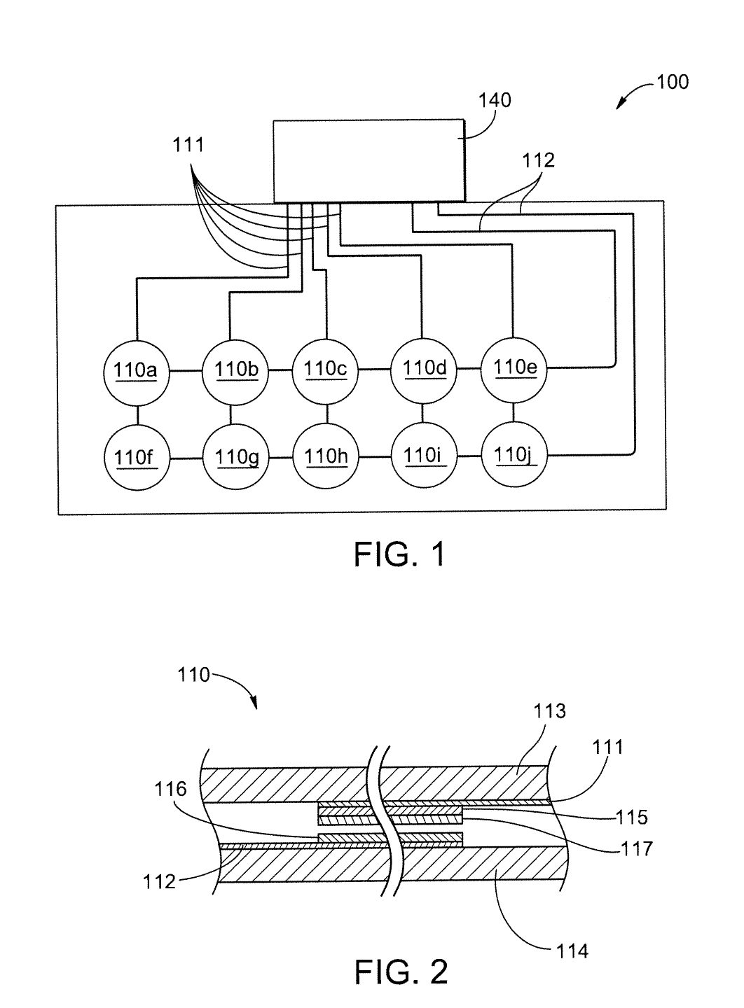

With reference to FIG. 1-2, a sensor sheet 100 generally includes one or more sensors 110. The sensors 110 are electrically coupled by input and output conductors 111, 112 to a controller or measuring device (not shown), which is configured to send and receive electrical signals to and from the sensors 110.

As shown in FIG. 2, the sensors 110 generally include sheets of carrier material 113, 114, conductors 111, 112, electrodes 115, 116, and a pressure sensitive material 117 configured in a generally symmetric, layered relationship (i.e., a carrier sheet, conductor, and electrode disposed on each side of the pressure sensitive material). As discussed in further detail below, the carrier sheets 113, 114, conductors 111, 112, electrodes 115, 116, and pressure sensitive material 117 may be selectively configured to change conductive characteristics of the sensors 110 according to the forces expected during a dynamic impact event.

The first and second carrier sheets 113, 114 may, for example, be configured to be outer and inner sheets relative to a surface of the crash test dummy 10. Each of the carrier sheets 113, 114 are made from a semi-rigid, sheet material. For example, each of the carrier sheets 113, 114 may be a polyethylene terephthalate (PET) sheet, having a thickness of approximately 50 microns. According to other exemplary embodiments, the carrier sheets 113, 114 may be made from other materials (e.g., polycarbonate, polyamide, other extruded plastic materials, multiple materials within one sheet, different materials for each sheet, etc.), have other thickness (e.g., between approximately 25 microns and 250 microns, varying thickness for one sheet, different thicknesses for different sheets, etc.).

Each of the conductors 111, 112 is configured to conduct electrical signals between the one of the sensors 110 and the controller or measuring device. The conductors are made from a conductive material, such as silver (Ag). The conductors 111, 112 are coupled, deposited, or applied to the carrier sheets 113, 114 through a printing process, such as two- or three-dimensional ink jet or screen printing, vapor deposition, or conventional printed circuit techniques, such etching, photo-engraving, or milling. The input conductor 111 may, for example, be coupled to an interior surface of the first carrier sheet 113, and the output conductor 112 may, for example, be coupled to an interior surface of the second carrier sheet 114. The conductors 111, 112 have a finished thickness of less than approximately 25 microns. According to other exemplary embodiments, the conductors 111, 112 may be made from other materials (e.g., copper (Cu) or other conductive materials, a combination thereof, etc.), may be made from different materials than each other, may have a different finished thickness (e.g., more or less than approximately 25 microns, varying thickness for each conductor, different thickness or different conductors, etc.), or be provided by other methods.

Each of the electrodes 115, 116 is configured to efficiently conduct electrical signals to or from the pressure sensitive material 117. The electrodes 115, 116 are made from a conductive material, such as carbon (C). The electrodes 115, 116 are coupled, deposited, or applied to the conductors 111, 112, and/or carrier sheets 113, 114, respectively, by a printing process, such as two or three-dimensional ink jet or screen printing, vapor deposition, or conventional printed circuit techniques, such etching, photo-engraving, or milling. The electrodes 115, 116 have a finished thickness of less than approximately 25 microns. According to other exemplary embodiments, the electrodes 115, 116 may be made from other materials, may be made from different materials than each other, may have a different finished thickness (e.g., approximately 25 microns or more, varying thickness for each electrodes, different thickness than other electrodes, etc.), be provided by different methods, or be provided in a different order (e.g., one of the electrodes may be applied to the pressure sensitive material 117).

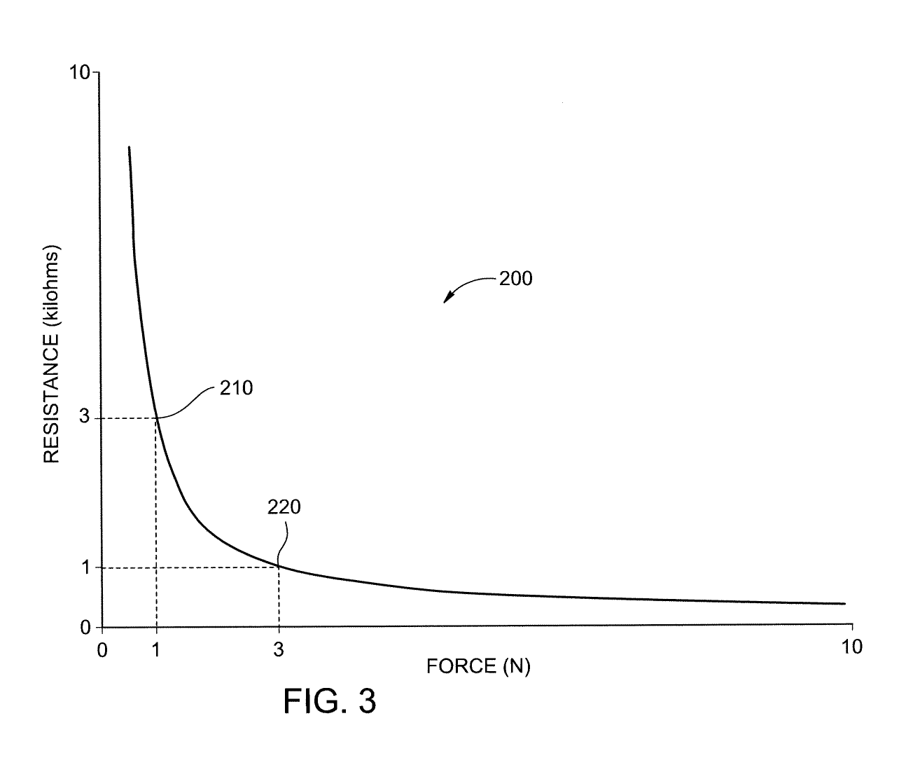

The pressure sensitive material 117 is configured to change resistance or conductive characteristics in response to force or pressure acting thereupon. More particularly, the pressure sensitive material behaves substantially as an isolator when no force or pressure is present and decreases in resistance as more force or pressure is present. Between low and high forces, the pressure sensitive material responds to force or pressure in a predictable manner, decreasing in resistance with increasing force. These characteristics are shown in the graph 200 of FIG. 3, which depicts the Resistance v. Force characteristics of a sensor 110 as described herein. FIG. 3 is discussed in further detail below.

The pressure sensitive material 117 may, for example, be a carbon nanotube conductive polymer. The pressure sensitive material 117 is applied to one of the electrodes 115, 116 by a printing process, such as two or three-dimensional ink jet or screen printing, vapor deposition, or conventional printed circuit techniques, such etching, photo-engraving, or milling. As pressure sensitive materials 117 are further developed with smaller particle size, such as that of graphine, the pressure sensitive material 117 may also be applied through conventional printed circuit techniques, such as vapor deposition.

According to other exemplary embodiments, the pressure sensitive material is a quantum tunneling composite (QTC), which is a variable resistance pressure sensitive material that employs Fowler-Nordheim tunneling. QTC is a material made by Peratech (www.peratech.com). The QTC material in the sensors 110 may act as an insulator when zero pressure or zero force is applied, since the conductive particles may be too far apart to conduct, but as pressure (or force) is applied, the conductive particles move closer to other conductive particles, so that electrons can pass through the insulator layer changing the insulator layer changing the resistance of the sensor 110. Thus, the resistance of the QTC in the sensors 110 is a function of the force or pressure acting upon the sensor 110.

The carrier sheets 113, 114 are coupled together to form the sensor sheet 100 after the conductors 111, 112, electrodes 115, 116, and pressure sensitive material 117 are deposited thereon. The carrier sheets 113 may, for example, be laminated together, such that the conductors 111, 112, electrodes 115, 116, and pressure sensitive material 117 are in proper alignment. The lamination process may for example be a conventional process using heat and pressure. Adhesives may also be used. The total thickness of the sensor sheet 100 and/or sensors 110 may be approximately 120 microns. According to other exemplary embodiments, the carrier sheets 113, 114 may, for example, be coupled together in other manners (e.g., laminating without heat or pressure). Further, the sensor sheet 100 and/or sensors 110 may have a different total thickness (e.g., greater than or equal to approximately 70 microns).

Now referring to FIG. 3, a graph 200 of the Resistance v. Force characteristics of a sensor 110 is shown. The resistance of the sensor 110 is shown on the Y-axis, and the force acting upon the sensor 110 is shown on the X-axis. At relatively low forces (e.g., at point 210 below approximately 1 N), the sensor 110 exhibits relatively high resistance characteristics (e.g., approximately 3 kilohm or higher) approaching approximately 300 or 400 megohms to behave substantially as an isolator. At relatively high forces (e.g., at point 220 above approximately 3 N), the sensor 110 exhibits relatively low resistance characteristics (e.g., approximately 1 kilohm or lower) approaching behaving substantially as a conductor. Between approximately 1 N and 3 N, the sensor 110 exhibits intermediate levels of resistance between approximately 3 kilohms and 1 kilohm that decreases in a predictable manner with increasing force.

The conductive characteristics of the sensor 110 (i.e., the Resistance v. Force characteristic curve 200) may configured according to the selection of different materials and providing different arrangements of the carrier sheets 113, 114, conductors 111, 112, electrodes 115, 116, and pressure sensitive material 117. For example, as described above, the conductive layers of the sensor 110 (i.e., the conductors 111, 112, electrode 115, 116, and pressure sensitive material 117) may be configured in different manners, such as with different materials and/or different thickness, to change the conductive characteristics of the sensor 110. Further, the pressure sensitive material may be configured by adjusting the component materials and/or blend of materials used to form the pressure sensitive material.

The carrier sheets 113, 114, may also be configured in different manners to change the conductive characteristics of the sensor 110. For example, the relative position of the carrier sheets 113, 114, may be adjusted. Referring to FIG. 2, the carrier sheets 113, 114 may be spaced apart in regions proximate the sensor 110 so as to provide a gap (as shown) between the pressure sensitive material 117 and the electrode 115. By providing a gap, a sufficient force must act upon the carrier sheets 113, 114 to deflect a corresponding distance before force acts upon the pressure sensitive material. Thus, referring to the graph of FIG. 3, the Resistance v. Force characteristics of the sensor 110 may be shifted rightward by a desired force offset (i.e., number of Newtons) by providing a gap of a certain size (e.g., 35 microns) corresponding to the spring rate of the carrier sheets 113, 114. The gap may, for example, be provided by an adhesive used to combine the carrier sheets 113, 114. According to another exemplary embodiment, the sensor 110 may be preloaded to have the opposite effect of a gap, such as with an externally provided physical load, effectively shifting the Resistance v. Force characteristics of the sensor 110 leftward.

The conductive characteristics of the sensor 110 may also be changed according to the materials used for the carrier sheets 113, 114. For example, if testing relatively high speed dynamic impact events, higher forces may be expected. A stiffer first or outer carrier sheet 113 may be provided, such as by utilizing a thicker material or a different material. By using a stiffer outer sheet 113, greater force must act upon the outer carrier sheet 113 to deflect a similar distance as compared to a less stiff material. Thus, referring to the graph of FIG. 3, the Resistance v. Force characteristics of the sensor 110 are elongated or extended (not shifted) rightward, such that for higher loads result, incremental changes of force result in larger changes of resistance to allow for more accurate detection by the controller or measuring device. The inner sheet 114 may also be configured to provide a stable base and may have a lower, same, or higher stiffness than the outer sheet 113.

While the sensors 110 have been described as being responsive to compressive loads, the sensors 110 are also responsive to bending loads that cause deflection of the carrier sheets 113, 114 and pressure sensitive material 117. Thus, for simple and/or reliable calibration, the pressure sensors 110 are maintained in a generally flat arrangement where measurements for compressive loads are desired. According to other exemplary embodiments, the sensors 110 may be utilized in applications where measurements for torsional or shear loads are desired.

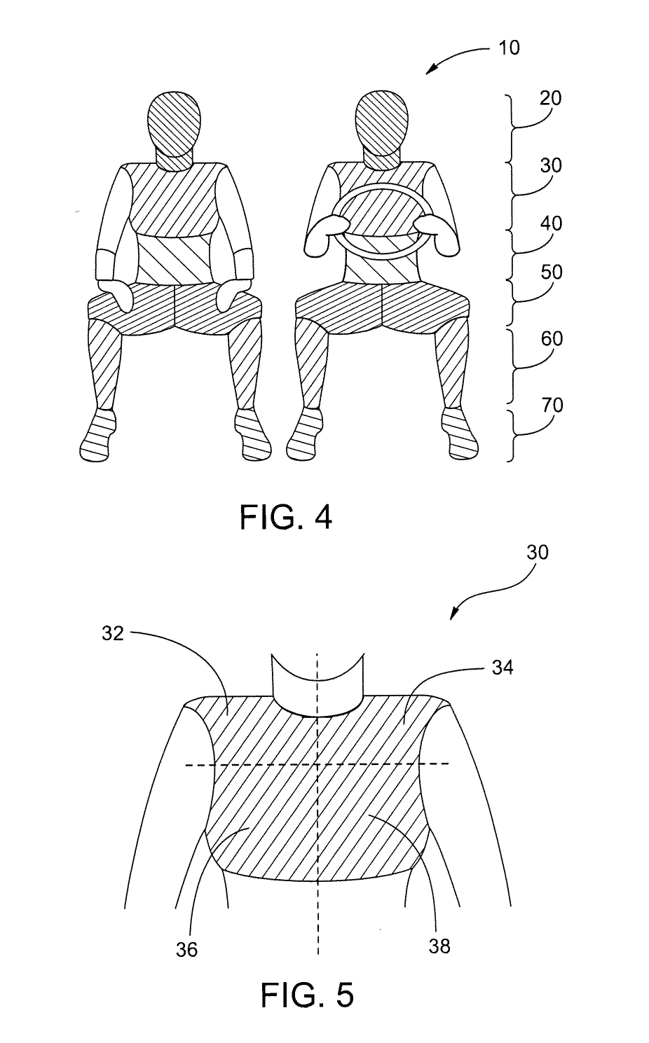

Now referring to FIG. 4, one or more sensor sheets 100 are provided for one or more zones of the crash test dummy 10. The zones may, for example, be divided into the following zones: a first zone 20 that includes the head, neck, and facial regions of the dummy 10; a second zone 30 that includes the upper chest and shoulders; a third zone 40 that includes the lower abdomen; a fourth zone 50 that includes the upper legs and pelvis; a fifth zone 50 that includes the lower legs; and, a sixth zone 70 that includes the feet. According to other exemplary embodiments, the zones may be configured in other manners including, for example, a different number of zones (e.g., more of fewer), larger or smaller zones (e.g., upper/lower body; feet/tibia/patella/femur), different divisions or groupings (e.g., chest/abdomen, left arm/shoulder, etc.), or any other suitable manner. Further, the crash test dummy may be any size, such as a 95^{th}, 5^{th}, or 50^{th} percentile dummy or an infant-sized dummy.

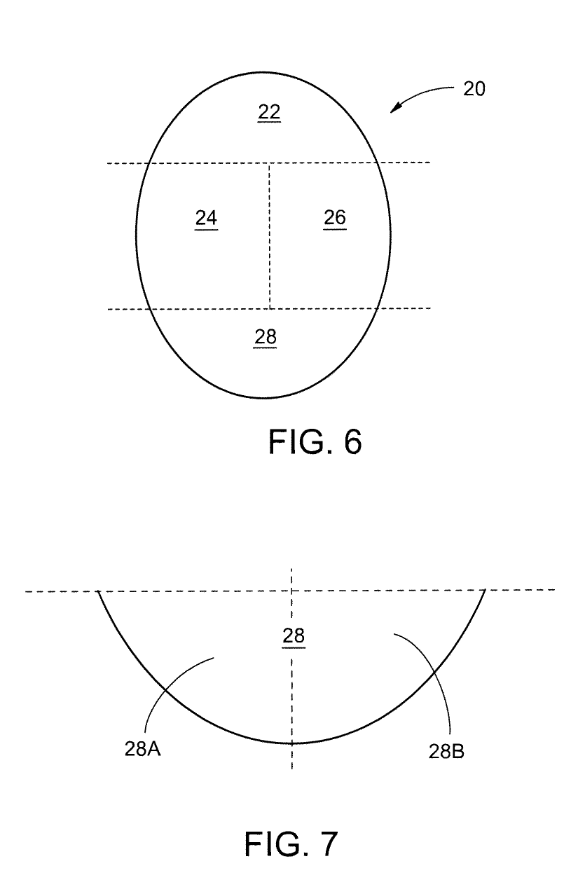

Referring to FIG. 5-6, each zone may be further divided into sub zones. For example, the second zone 30 (i.e., upper chest and shoulders) shown in FIG. 5 may be divided into the following sub zones: right shoulder 32; left shoulder 34; right chest 36; and, left chest 38. As another example, the first zone 20 (i.e., head, neck, and facial regions) may be divided into the following sub zones: forehead 22, right face 24, left face 26, and chin 28. Referring to FIG. 7, each subzone may be further subdivided. For example, the chin sub zone 28 may be divided into right chin 28A and left chin 28B divisions.

Each sensor sheet 100 may be configured according to the anatomical features of the corresponding zone or sub zone and/or the type of dynamic impact event to be tested. More particularly, each sensor sheet 100 may include one or more sensors 110 configured according to position, conductivity characteristics, and/or shape and size. Individual sensors 110 may be positioned over prominent anatomical structures that may be impacted by certain vehicle features. For example, sensors may be placed in the following positions for different zones: the first zone 20 on the chin, cheekbones, bridge of nose, forehead and other locations on the skull; the second zone 30 on shoulders and ribs; the fourth zone 50 on the knees and hips; the fifth zone 60 on the shins; and, the sixth zone 70 on the feet. Sensors 110 may also be positioned over soft tissue anatomical surfaces, which may, for example, include temples and the abdomen. If force mapping is desired, such as where forces are distributed over a larger area (e.g., the chest or abdomen being impacted by the dashboard or airbag), the sensor sheet 100 may include group of sensors with regular spacing (such as that shown in FIG. 1) having the same resistance or conductivity characteristics as each other. Sensors 110 may, for example, have a diameter of approximately 10 mm and regular spacing of approximately 25 mm. According to other exemplary embodiments, the sensors 110 may be smaller, larger, of different shape, and/or have more or less spacing.

Sensors 110 may also be positioned according to the dynamic event to be tested, the safety device or system to be evaluated, and/or other factors, which may determine the forces desired to be measured. For example, when testing frontal or side impact events, sensors 110 may accordingly be concentrated in locations toward the front or side of the crash test dummy 10. If testing for airbags, seatbelts, or other safety features, the sensors 110 may be provided only in locations proximate such features. Sensors 110 may also be positioned for out-of-position occupants.

The conductivity characteristics of the sensors 110 (i.e., the Resistance v. Force characteristics) may also be configured according to expected forces in the position of the sensor 110. For example, if higher localized forces are expected, such as on protruding anatomical features (e.g., nose, chin, shoulder, knees, hips, etc.) or for higher speed events, sensors 110 may be configured to be more responsive to higher forces (i.e., be configured to have larger changes in resistance for incremental changes of force at higher levels). Such sensors 110 may, for example, be configured with a stiffer outer carrier sheet 113 or with a gap between the pressure sensitive material 117 and the electrode 115 as described above.

The size and shape of the sensors 110 may also be configured according to various considerations. For example, in heavily contoured areas, such as the facial region, smaller sensors may be utilized, such that the sensors 110 may be maintained in a generally flat or planar arrangement to avoid inaccurate measurements from torsional loads acting upon to the sensors 110. Larger sensors 110 may, for example, be provided in areas where only generalized load information is desired (e.g., total load over a broad area). Further, shear sensors may be utilized in highly contoured area, such as the nose. Elongate sensors 110 may, for example, be provided over elongate anatomical features (e.g., arms, legs, etc.). According to other exemplary embodiments, the size and shape of the sensors 110 may be configured in other suitable manners according to various other considerations.

The sensor sheet 100 may also be configured in other manners to maintain a generally flat or planar arrangement for the sensors 110. For example, between the sensors 110, the sensor sheet 100 may include weakened (i.e., less stiff) portions configured to bend instead of the sensors 110, such as from thinner or removed carrier material in those areas. According to another exemplary embodiment, the sensors 110 may be individually coupled to a flexible overlay, such as a woven fabric or elastomeric sheet. According to yet another exemplary embodiment, the sensors 110 are individually coupled to a flexible member contoured according to the corresponding zone. For example, a molded, elastomeric mask may include individual sensors 110 coupled thereto for the first zone 20.

Each sensor sheet 100 is coupled to the crash test dummy 10. The sensor sheets 100 may be removably coupled to the dummy 10 such as with adhesives, fasteners, straps, hook and loop fasteners, etc. The sensor sheets 100 may be removed from the dummy 10, for example, to be used on another dummy 10 or for repair, or to free the dummy 10 for other testing. According to other exemplary embodiments, the sensor sheets 100 may be irremovably coupled to the dummy 10 or be integrally formed with the outer surface of the dummy 10, such that the sensor sheets may not be removed from the dummy 10.

Each sensor sheet 100 may be configured for use in a portion of a zone, one full zone, or more than one zone. For example, a first sensor sheet 100 may be provided for the first zone 20; a second sensor sheet 100 may be provided for the second and third zones 30, 40 together; a third sensor sheet 100 may be provided for the left side of the fourth zone 50; a fifth sensor sheet 100 may be provided for the right side of the fourth zone 50; a sixth sensor sheet 100 may be provided for the right sides of the fifth and sixth zones 60, 70; and, a seventh sensor sheet 100 may be provided for the left sides of the fifth and sixth zones 60, 70. According to other exemplary embodiments, sensor sheets 100 may be provided in different configurations including, for example, a different number of zones (e.g., more or fewer than six zones), different combinations or divisions of zones (e.g., first and second zones 20, 30 together, separate sensor sheets 100 for upper and lower portions of individual zones, etc.).

Each sensor sheet 100 may further include sensors configured to measure forces in different manners. For example, a sensor sheet may include sensors 110 configured to measure localized forces for one zone or subzone and include sensors 110 configured for measuring a distribution of forces for another zone. According to other exemplary embodiments, the sensor sheet 100 may include sensors 110 in other configurations including, for example, sensors configured only for one type of force measurement (e.g., localized or distributed).

The sensors 110 may further be configured to provide measurements in parallel or in series. For example, the conductors 111, 112, may be arranged such that the sensors 110 are configured in parallel to provide discreet measurements for each sensor 110. The conductors 111, 112, may instead be arrange such that the sensors 110 are configured in series to provide aggregated force measurements at the benefit of reduced noise or smoothed output and reduced power of the controller.

The sensors 110 may also be configured to provide the location of the force acting thereupon. Two sets of output conductors 112 are provided for each sensor 110 that enable determining the average position of the forces acting upon the sensor 110. The two sets of output conductors 112 behave essentially as a voltage divider with voltages for each output conductor 112 varying according to the position of the force relative to the position of each output conductor 112.

The sensor sheet 100 and sensors 110 may also be configured to couple to a structure, safety device, or other feature of a vehicle. For example, a sensor sheet 100 may be configured to be applied to a pillar of (e.g., A or B pillar) with sensors 110 for measuring the forces of the crash test dummy 10 impacting the pillar during a simulated dynamic vehicle event. Sensor sheets 100 and sensors 110 also be configured and provided for being applied to a door panel, dashboard or instrument panel, seat belt, headliner, seat belt, transmission tunnel, floor pan, seat assembly, etc. The sensor sheets 100 and sensors 110 may be configured and/or manufactured in the manners described.

The sensor sheet 100 and sensors 110 may also be configured to be disposed under an outer surface of the crash test dummy 10, such as an elastomer or simulated skin material. The outer surface may, for example, provide a preload to the sensors 110 as described above, protect the sensor sheet 100 and sensor sheets 110, and/or distribute forces to the sensors 110.

The sensor sheet 100 and sensors 110 may also be configured for use with safety devices or other types of devices that are removable from a vehicle. For example, the sensor sheet 100 and sensors 110 may be configured to be coupled to a child safety seat, such as an infant seat, convertible child seat, or booster seat. One or more sensor sheets 100 having one or more sensors 110 may be coupled to a seating or structural surface of the child seat, seat belt, buckle mechanism, etc. of the child seat.

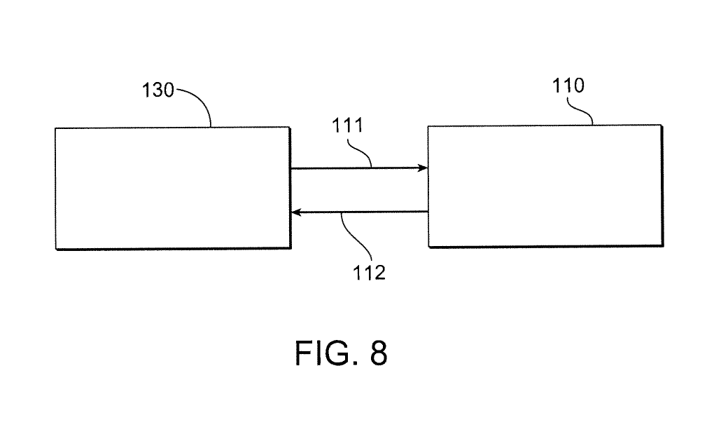

Referring generally to FIG. 8, the sensing system 10 includes a controller 130 or measuring device configured measure the forces acting upon to each of the sensors 110. The controller or measuring device generally includes a signal source (e.g., voltage or current source), a measuring circuit for measuring the output of the sensors 110 (e.g., voltage or current), a processing circuit for converting sensor 110 output current or voltage into a force value, and memory for storing programming for converting sensor 110 outputs into force values and for recording measured sensor 110 outputs and/or force values. The controller or measuring device is electrically coupled to each of the sensors 110 on each of the sensor sheets 100 by way of the conductors 111, 112 and a port 140. The controller or measuring device is configured to send electrical signals to each of the sensors 110, receive signals from each of the sensors 110, and record and process signals received from each of the sensors 110. More particularly, the controller or measuring device selectively produces a DC signal of approximately 10 volts at a current of approximately 1 milliamp through the input conductors 111 to each of the sensors 110. The controller or measuring device then receives a return signal for each sensor 110 through the output conductors 112, which is recorded at a sampling rate of 1000 Hz. According to other exemplary embodiments, signals may be send at higher or lower voltage (e.g., between approximately 3 and 24 volts) or current (e.g., between approximately 100 microamps and 1 milliamp) and may be recorded at a higher or lower sampling rate.

The controller or measuring device then compares the input and output signals to determine the voltage across each sensor, which is recorded and then processed to determine the corresponding load. If, for example, no or little force acts upon a sensor 110, the sensor 110 behaves as a near perfect isolator and a complete or near complete voltage drop is measured across the sensor 110. If, for example, high force acts upon the sensor 110, the sensor 110 behaves as a near perfect conductor and no or an incomplete voltage drop is measured across the sensor 110. If, for example, an intermediate force acts upon the sensor 110, the sensor 110 behaves a partial resistor/conductor, and a partial voltage drop is measured across the sensor 110. Based on the voltage measured across each sensor 110 and the particular Resistance v. Force characteristics of the sensor 110, the controller or measuring device processes the voltage across the sensor 110 to determine the force acting upon the sensor 110.

The controller or measuring device may, for example, be a single unit configured to send, receive, record, and process signals. According to other examples, the controller or measuring device may include separate component devices configured to do one or more of the sending, receiving, recording, and processing functions. Each of the sending, receiving, recording, and processing functions may also be provided by more than one component device (e.g., one device measures voltage, another device records the voltage, and yet another device processes the recorded voltage). Further, multiple controller or measuring devices may be provided, such as one or more for each sensor sheet 100.

The force measurements from each sensors 110 may be processed and/or utilized in various manners, such as for determining localized forces, force distribution, time to first contact, secondary impacts, and/or duration of an impact. Localized forces may be determined for each sensor. Force mapping or distribution may be determined for a group of sensors, particularly those which are spaced at regular intervals. Force data collected from the sensors 110 may be used by itself or may be used in conjunction with data collected according to conventional systems (e.g., accelerometers, load cells, and/or cameras).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the crash test dummies as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A system for measuring forces during a simulated dynamic vehicle event comprising:
a plurality of sensors positioned to be exposed to the forces to be measured,
a controller electrically coupled to each of the plurality of sensors;
wherein each of the plurality of sensors includes a layer of pressure sensitive material arranged between an outer sheet of carrier material and an inner sheet of carrier material,
wherein the resistance of the pressure sensitive material is configured to change in response to forces acting upon the outer sheet of carrier material,
wherein each of the plurality of sensors is configured to be coupled to a surface of a crash test dummy or to a surface of a vehicle, and
wherein the controller is configured to provide an electrical signal to each sensor, to measure the voltage across each sensor, and to determine the force acting upon each sensor based on the measured voltage.

2. The system of claim 1 wherein a sensor sheet comprises one or more sensors, the conductors, and the outer and inner sheets of carrier material.

3. They system of claim 2 wherein the sensor sheet is configured to be coupled to the surface of a crash test dummy.

4. The system of claim 3 wherein the sensor sheet comprises weakened portions of carrier material between the sensors.

5. The system of claim 3 wherein one or more of the plurality of sensors is configured to measure force acting upon an anatomical feature of the crash test dummy.

6. The system of claim 5, wherein the one or more sensors are configured to measure localized forces acting upon an anatomical structure of the crash test dummy.

7. The system of claim 6 wherein the one or more sensors are disposed in a position on the sensor sheet, which corresponds to a position of the anatomical structure on the crash test dummy.

8. The system of claim 5, wherein the two or more sensors are configured to measure distributed forces acting upon an anatomical surface of the crash test dummy.

9. The system of claim 8 wherein the two or more sensors are disposed on the sensor sheet in regular intervals.

10. The system of claim 5 wherein the two or more sensors are disposed under an outer surface of the crash test dummy.

11. The system of claim 2 comprising two or more sensor sheets.

12. The system of claim 1 wherein the pressure sensitive material of each sensor behaves substantially as an isolator when no force acts upon that sensor and decreases in resistance when force acts upon that sensor.

13. The system of claim 12 wherein the pressure sensitive material is a quantum tunneling composite.

14. The system of claim 2 wherein the pressure sensitive material and conductors are coupled to one or both of the outer and inner carrier sheets.

15. The system of claim 14 wherein
each sensor includes a first and second electrode,
a first set of conductors is printed onto an interior surface of either the outer or inner carrier sheets,
a second set of conductors is printed onto an interior surface of the other of the outer and inner carrier sheets,
the first electrodes are printed onto the first set of conductors,
the second electrodes are printed onto the second set of conductors, and
the pressure sensitive material for each sensor is printed onto either the first or second electrode of that sensor.

16. The system of claim 15 wherein the outer and inner carrier sheets are coupled together to form the sensor sheet, such that the first electrode, second electrode, and pressure sensitive material of each sensor are in alignment.

17. A sensor for measuring forces during a simulated dynamic vehicle event comprising:
an outer carrier sheet and an inner carrier sheet,
a first conductor and a second conductor, and
a pressure sensitive material that changes electrical resistance in response to force acting upon the pressure sensitive material, wherein
the first conductor is coupled to an interior surface of the outer carrier sheet,
the second conductor is coupled to an interior surface of the inner carrier sheet,
the pressure sensitive material is physically and electrically coupled to one of the first and second conductors, and
the sensor is configured to be coupled to a surface of a crash test dummy or to a surface of a vehicle.

18. The sensor of claim 17 wherein the pressure sensitive material behaves substantially as an isolator with no force acting thereupon and decreases in resistance when force acts thereupon.

19. The sensor of claim 18 configured to be coupled to a surface of a crash test dummy.

20. The sensor of claim 19 further comprising a first electrode and a second electrode, wherein
the first conductor is a printed layer on the outer carrier sheet,
the second conductor is a printed layer on the inner carrier sheet,
the first electrode is a printed layer on the first conductor,
the second electrode is a printed layer on the second conductor, and
the pressure sensitive material is a printed layer on either the first electrode or
the second electrode.
